(19) United States
(12) Patent Application Publication
(10) Pub. No.: US 2015/0332613 A1
(43) Pub. Date: Nov. 19, 2015

(54) SECURITY MARKER

(71) Applicant: SmartWater Ltd, Liverpool (GB)

(72) Inventor: Michael Cleary, Liverpool (GB)

(73) Assignee: SMARTWATER LTD, Liverpool (GB)

(21) Appl. No.: 14/714,168

(22) Filed: May 15, 2015

Related U.S. Application Data
(60) Provisional application No. 61/993,482, filed on May 15, 2014.

(51) Int. Cl. G09F 3/02

(52) U.S. Cl. CPC G09F 3/02; G09F 2003/0211; G09F 2003/0213; G09F 2003/0257

(57) ABSTRACT

A security marker is disclosed which may include (i) a first level of the marker which is an indicator, and (ii) a second level of the marker which is a characteristic fingerprint, wherein the marker is configured such that an identification of the first level of the marker (e.g., the identification of the indicator or its nature) provides information to identify the second level of the marker (e.g. to identify a nature or characteristic of the second level of the marker such as to identify that the second level of the marker is a fingerprint). Therefore, advantageously, the identification of the first level of the marker may provide key information for identifying the what the second level of the marker may be and/or a characteristic of that second level, e.g., a type of fingerprint being used.

### CROSS-REFERENCE TO RELATED APPLICATIONS

The subject application claims priority to U.S. Provisional Application No. 61/993,482, entitled “An Improved Security Marker,” filed May 15, 2014, the contents of which are hereby incorporated herein.

### TECHNICAL FIELD

The present disclosure relates to security measures and in particular, security measures which may be used in the identification/authentication of goods so as to be able to, for example, distinguish original goods from counterfeit goods and to identify stolen goods or articles.

### BACKGROUND

There is an ever increasing level of crime in terms of the theft of valuable items. Goods not previously thought to be valuable are now also subjected to theft. In addition, profits from the production of counterfeit goods continues to rise. This is an international crime that has grown over recent years such that it is estimated to account for 6% of world trade and is increasing rapidly.

The use of a marker system in a court of law does require a guaranteed level of utility. Clearly, the reliability of any given marker system may be demonstrated through repeated successful outcomes within a criminal justice system. A system incorporating multiple independent markers, the analysis of which would provide increased verification of an authenticity of the marker.

Various measures have also been put into place to help distinguish between a genuine product and a counterfeit copy. Complex labelling is used in the form of branding and logo's as the first line of defense. However, the funds available to counterfeiters are such that they can use the highest quality printing methods to duplicate the branding themselves, so that the logo's and labels become counterfeit. In order to combat this, complex features that are difficult to copy have been added by manufacturers to make any copying more difficult. Such features include bar-coding, reflective and refractive inks and holograms.

However, these measures have also been copied and accordingly manufacturers have adopted the approach of adding markers to their products as a further way of deterring the production of counterfeits. Several different types exist that are both overt and covert. Overt markers are visible under normal lighting and can be designed in many different ways that are difficult to reproduce exactly. Others are covert and require some form of stimulation before they can be seen. These can also contain various features that are difficult to reproduce such as for example a random pattern.

A further type of marker system which may be used contains a covert fingerprint within the marker. One of the first such systems involved the use of DNA fingerprints containing artificially produced base sequences which provided a unique identification of the item to which it was applied. However, one weakness of DNA lies in its relative fragility and so this may be degraded through sunlight, heat or alkaline conditions.

The damage to a DNA molecule used as a security marker caused by exposure to aggressive radiation, heat, humidity, pH or chemicals will result in a failure to identify any fingerprint upon analysis. This could result in genuine items being classed as counterfeit and the legal ramifications and costs to both sides in the legal disputes that will follow will be enormous.

### SUMMARY

The present disclosure is concerned with an improved security marker that may be used to recover stolen goods and in the authentication of goods so as to be able to, for example, distinguish original goods from counterfeit goods and to identify stolen goods or articles.

The present disclosure provides an improved marker based upon multiple components or facets each of which has an inherent stability greater than that of DNA and which, in combination, present a formidable obstacle to those involved in the theft of goods or in the production of counterfeit items.

Therefore, according to a first aspect of the present disclosure there is provided a security marker which may include (i) a first level of the marker which is an indicator, and (ii) a second level of the marker which is a characteristic fingerprint, wherein the marker is configured such that an identification of the first level of the marker (e.g., the identification of the indicator or its nature) provides information to identify the second level of the marker (e.g. to identify a nature or characteristic of the second level of the marker such as to identify that the second level of the marker is a fingerprint). Therefore, advantageously, the identification of the first level of the marker may provide key information for identifying the what the second level of the marker may be and/or a characteristic of that second level, e.g., a type of fingerprint being used.

In an example embodiments, a security system may be provided which includes, both a security marker, such as described herein, and an analysis tool configured for enabling analysis of a first level of the marker, such as an indicator (as described herein), in order to facilitate or enable identification of the first level of the marker or a characteristic thereof. In further example embodiments, the security system may also include correlation information adapted for facilitating or enabling identification of a nature or characteristic of a second level of a marker, such as the existence of a fingerprint or type characteristic thereof, based on the identification of the first level of the marker or the characteristic of the first level of the marker.

In some embodiments, the analysis tool may include a stimulation mechanism for stimulating the first level of the marker, e.g., for stimulating the indicator, such as to cause the cause the first level of the marker to exhibit an observable property/characteristic. In example embodiments, the observable property/characteristic may be hidden/less observable prior to the stimulation. Example properties/characteristics may include photo-responsive properties/characteristics (e.g., florescence, directionally specific reluctance patterns, etc.) thermo-response properties/characteristics (e.g., thermochromic), electro-responsive proprieties/characteristics, mechanically-responsive properties/characteristics or other types of properties/characteristics responsive to different types of stimuli. In further example embodiments, the analysis tool may include an examination mechanism for examining and qualifying or quantifying a response of the first level of the marker to the stimulus, e.g., by observing a property/characteristic of the first level of the marker impacted by the stimulation.

In some embodiments the correlation information may operatively associated with the analysis tool, e.g., so as to enable automatic identification of the nature or characteristic of the second level of the marker based on the identification of the first level of the marker or the characteristic of the first level of the marker using the analysis tool. Thus, in some embodiments, the correlation information and analysis tool may be operatively associated with a processor configured, e.g., via association with non-transient processor executable instructions, to enable the automatic identification of the nature or characteristic of second level of the marker based on the identification of the first level of the marker or the characteristic of the first level of the marker using the analysis tool and the correlation information. In such embodiments the processor may further be associated with non-transient memory adapted for storing the processor executable instructions, the correlation information and/or data received from the analysis tool, e.g., relating to the identification of the first level of the marker or the characteristic of the first level of the marker.

In some embodiments, the correlation information may be provided as a reference to enable identification of the nature or characteristic of the second level of the marker based on the identification of the first level of the marker or the characteristic of the first level of the marker using the analysis tool or other observational means (such as human-based observation) which may be with or without stimulation of the first level of the marker. Notably, while in some embodiments the identification of the nature or characteristic of the second level of the marker may be automated, e.g., utilizing a processor as described herein, in other embodiments the identification of the nature or characteristic of the second level of the marker may be a human-aided process, e.g., based on the reference provided by the correlation information.

While in preferred embodiments, the first level of the marker may be an indicator and the second level of the marker may be a fingerprint, other types of features may be used such as described herein. Moreover, while in some embodiments the first level of the marker may be an initial level of the marker, in other embodiments the first level of the marker may be a secondary or tertiary identification feature. Thus, the terms first and second are only intended to denote a relative sequence as between the first and second levels of the marker.

In a further aspect of the disclosure, there is provided, a multilevel security marker containing multiple components, wherein each component is provided with one or more of a series of hierarchical codes or identifiers such that the identification of the first of the codes or identifiers in the series in any given component identifies a nature/characteristic of the next code or identifier in a same or a different component of the marker.

In a further aspect of the disclosure, there is provided a security marker for use within a criminal justice system and in the detection of counterfeit goods the security marker including as individual features/components an indicator, a characteristic fingerprint and a polymer base. Notably, each component may be provided with one or more in a series of hierarchical codes or identifiers such that the identification of a first of the codes or identifiers in the series in any given component identifies the nature of the next code or identifier in the same or a different component.

In an even further aspect, the present disclosure comprises a method of verifying the authenticity of an item may include the steps of: (i) applying a marker to an item; (ii) recording the details of the batch of the marker, (iii) subjecting the marker to a stimulus which identifies the position/nature of the marker, (iv) conducting an established first analysis by comparing the results to the recorded details, the results from which indicate what other identification means (features/components) are present in the batch of the marker and (v) performing each of the forms of analysis as indicated to verify the authenticity of the item.

In a further aspect, the present disclosure comprises a security method which may include the steps of: (i) providing an item having a security marker characterized by a first interrogation level; (ii) examining the first interrogation level to identify one or more characteristics of the first interrogation level representing a marker code for the first interrogation level; (iii) utilizing a predetermined correlation to interpret the marker code for the first interrogation level and thereby identify a second interrogation level of the marker; (iii) examining the second interrogation level of the maker to identify one or more characteristics of the second interrogation level; and (iv) making a security determination with respect to the item (e.g., authenticity or whether it was stolen) based at least in part on the identified one or more characteristics of the second interrogation level.

### BRIEF DESCRIPTION OF THE DRAWINGS

The above and other aspects, features and advantages of the disclosure will be apparent from the following more particular description of examples, as illustrated in the accompanying drawings, in which:

FIG. 1 depicts an exemplary security marker and related systems and methods according to the present disclosure.

### DETAILED DESCRIPTION

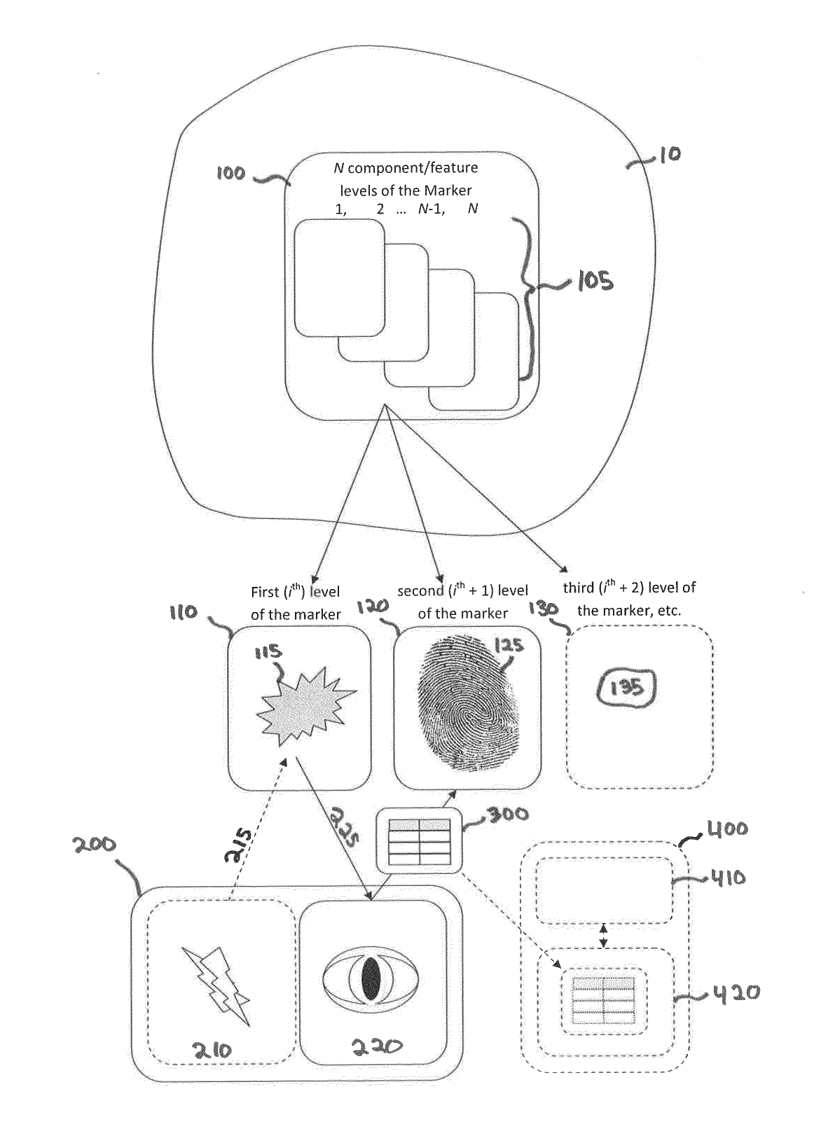

With reference to FIG. 1, an exemplary security marker 100 is depicted. Security marker 100 may advantageously be associated with an protected item 10, such as a consumer product requiring identification/authentication. In general, the security marker 100 may include a plurality of components/features characterizing different interrogation levels of the marker 100. The N component/feature levels 105 of the marker 100 may represent the batch information for the marker and may be known/recorded at the time of creation of the marker 100.

In exemplary embodiments, the marker 100 may include at least a first level 110 of the marker and a second level 120 of the marker. While in preferred embodiments, the first level 110 of the marker may be an indicator 115 (e.g., a florescent type indicator) and the second level 120 of the marker may be a fingerprint 125, other types of components/features may be used such as described herein. Moreover, while in some embodiments the first level 110 of the marker may be an initial interrogation level of the marker, in other embodiments the first level 110 of the marker may be a secondary or tertiary interrogation level. Thus, sequence terms such as first, second, etc. as used with respect the levels of the maker are only intended to denote a relative sequence, e.g., such as a first level preceding the second level, and not an absolute sequence with respect to all interrogation levels of the marker. In some embodiments, the marker 100 may further include a third level 130 of the marker, e.g., representing a third interrogation level in the sequence. In preferred embodiments, the third level 130 may be a polymer base 135, as described herein.

Advantageously the marker 100 may be configured such that an identification of the first level 110 of the marker (e.g., the identification of the indicator 115 or its nature) provides information to identify the second level 120 of the marker (e.g. to identify that the second level of the marker is a fingerprint 125). In particular, the identification of the first level 110 of the marker may provide key information for identifying what the second level of the marker may be and/or a characteristic of that second level, e.g., a type of fingerprint being used. In some embodiments, the security marker 100 may be a multilevel security marker containing multiple components/features, wherein each component is provided with one or more of a series of hierarchical codes or identifiers such that the identification of the first of the codes or identifiers in the series in any given component/feature identifies a nature/characteristic of the next code or identifier in a same or a different component/feature of the marker. It may generally pre-determined, e.g., during or before batch preparation, how a marker levels may interrelate under a hierarchical system. Thus, only one with knowledge of the underlying hierarchical system is able to correctly follow the links in the chain from identification of the first level to identification of the second level, etc.

In an example embodiments, a security system may be provided which includes, both a security marker 100, such as described herein, and an analysis tool 200 configured for enabling analysis of a first level 110 of the marker (such as an indicator 115) in order to facilitate or enable identification of the first level 110 of the marker or a characteristic thereof. In further example embodiments, the security system may also include correlation information 300 (e.g., of an underlying hierarchical system) adapted for facilitating or enabling identification of a nature or characteristic of a second level 120 of the marker, e.g., based on the identification of the first level 110 of the marker or the characteristic of the first level 110 of the marker.

In some embodiments, the analysis tool 200 may include a stimulation mechanism 210 for stimulating 215 the first level 110 of the marker such as to cause the cause the first level 110 of the marker to exhibit an observable property/characteristic. In example embodiments, the observable property/characteristic may be hidden/less observable prior to the stimulation 215. Example properties/characteristics may include photo-responsive properties/characteristics (e.g., florescence, directionally specific reluctance patterns, etc.) thermo-response properties/characteristics (e.g., thermochromic), electro-responsive proprieties/characteristics, mechanically-responsive properties/characteristics or other types of properties/characteristics responsive to different types of stimuli 215. In further example embodiments, the analysis tool 200 may include an examination mechanism 220 for examining 225 the first level 120 of the marker, e.g., for qualifying or quantifying a response of the first level 120 of the marker to the stimulus 215. Thus, the examination mechanism may be configured for observing, qualifying and/or quantifying a property/characteristic of the first level of the marker (e.g., a property/characteristic impacted by stimulation 215) to facilitate/enable the identification of the first level 110 of the marker.

With reference still to FIG. 1, in some embodiments the correlation information 300 may operatively associated with the analysis tool 200, e.g., so as to enable automatic identification of the nature or characteristic of the second level 120 of the marker based on the identification of the first level 110 of the marker or the characteristic of the first level 110 of the marker using the analysis tool 200. Thus, in some embodiments, the correlation information 300 and analysis tool 200 may be operatively associated with processing system 400 including a processor 410 configured, e.g., via association with non-transient processor executable instructions, to enable the automatic identification of the nature or characteristic of second level 120 of the marker based on the identification of the first level 110 of the marker or the characteristic of the first level 110 of the marker using the analysis tool and the correlation information. In such embodiments the processor may further be associated with non-transient memory 420 adapted for storing (i) the processor executable instructions, (ii) the correlation information 300 and/or (iii) data received from the analysis tool 200, e.g., relating to the identification of the first level 110 of the marker or the characteristic of the first level 110 of the marker.

In other embodiments, the correlation information 300 may be provided as a reference to enable identification of the nature or characteristic of the second level 120 of the marker based on the identification of the first level 110 of the marker or the characteristic of the first level 110 of the marker using the analysis tool 200 or other observational means (such as human-based observation) which may be with or without stimulation 215 of the first level 110 of the marker. Notably, while in some embodiments the identification of the nature or characteristic of the second level of the marker may be automated, e.g., utilizing a processing system 400 as described herein, in other embodiments the identification of the nature or characteristic of the second level 120 of the marker may be a human-aided process, e.g., based on a user referencing the correlation information 300.

As noted above, a security marker, such as described with respect to FIG. 1, may advantageously, be based upon a combination of components each one of which can be of variable composition. The facets, components or parts of the marker, may each be coded in some way. Typical facets include:
DNA
Chemical fingerprint
Metal based fingerprint
Coded particles
Polymer combinations and ratios

In the embodiment where DNA is included in any given batch of the marker, the code may be based upon base pair sequences.

In the embodiment where a chemical fingerprint is included, the code may contain a unique combinations of materials, such as for example trace elements in a particular combination.

If a metal based fingerprint were included the code may be based on unique combinations of metal based materials.

If coded particles were included then they could be numerically or colour coded.

If polymer combinations were included then they could be include one or more different polymers.

If polymer ratios were included then more than one polymer could be included in a specific ratio.

Therefore, in order to duplicate the marker according to the present disclosure, a potential counterfeiter is required to determine which of the above components is present and duplicate it. They would, for example, have to determine if the polymer used in the marker formulation is part of the marker code or just an off the shelf product generally available. When used within a criminal justice system it provides a second independent validation of the result and the marker code.

The present disclosure, therefore, provides a marker of immense complexity. Only those with the manufacturing records are in a position to know what facets have been added to a particular batch of product. Would be counterfeiters will not know what facets they should be copying.

It therefore represents an improvement over existing marker systems in that it provides a marker system with a far greater resistance to copying than any current marker system and with a method of internal validation.

The manufacturer of the genuine item, or those acting on behalf of the manufacturer, would know what features should be present on any given batch of product based upon the manufacturing records for each product. This information is based upon the first analysis undertaken which provides the data necessary for the manufacturer to gain access to the relevant entry in his records.

The marker preferably comprises an indicator material, which can quickly provide a preliminary, gross indication of the presence of a composition according to the present disclosure. The indicator material can either be “overt” or “covert.” An overt material is typically one which can be seen unaided by technology, such as a dye or pigment. With an overt indicator, it is immediately evident from an observation of the article or person that a mark has been provide thereon which may act as a deterrent. In one embodiment both a covert and overt mark may be applied thus combining the deterrent effect of the overt mark with the covert properties of the covert mark. For example, if the overt mark failed to act as a deterrent and the perpetrator tried to remove the overt mark; even if they were successful the stolen item could nevertheless still be identified by virtue of the covert mark.

A covert indicator will remain hidden until some technical means or stimulus is used to make it obvious. Usually, a covert indicator will become visible upon application of a radiation source other than visible light, and of these, fluorescent indicators are most common. Thus, the covert indicator will often be at least one fluorescent material which is soluble in a solvent system, and which is easily detectable upon examination with ultraviolet light, for example.

It is possible to utilise a fluorescent material which when exposed to UV light fluoresces in a particular colour, each particular fluorescent material being selected for a particular customer, so that when the composition containing the selected fluorescent material is applied to a surface of articles or goods, then any unauthorised removal of such articles or goods can be linked back to the particular customer as the source of goods. It is further possible to utilise a combination of two or more fluorescent materials having differing A max emission wavelengths.

It is possible to identify said two or more materials by utilising a UV-absorption spectrum or a fluorescent emission spectrum of an indicator. Accordingly, such combination of materials, when applied to a surface of articles or goods, can also be used to link the particular goods to the customer. Alternatively or additionally, the indicator may comprise at least one phosphorescent material capable of phosphorescing when subjected to stimulus.

The indicator is preferably utilised in spray form and can be combined with various solvent systems and surfactants. When the gross indicator means is fluorescent, the composition can include one or more of any suitable fluorescent materials.

In terms of suitable indicators, both organic and inorganic materials were tested. Some organics, especially of the oxazinone functionality performed well, but did still degrade well below the required temperature and lost their fluorescence.

A preferred compound for use in the present disclosure as an indicator is an inorganic emitter.

The fundamental role of the indicator is to be recognised as such, to identify the type of marker in use and its location. To this end the initial function of the indicator will remain unchanged and provide a consistent output. In the case of a covert indicator however once the required output has been obtained then the indicator may be probed with different forms of stimulation to determine if any further output is obtained that may provide information on the further analyses to be undertaken.

At this second level the colour of the indicator, to those with the necessary information, could be used to indicate just the first feature to be analysed. The result from this analysis can then be used to determine what other possible components are present in any given marker on any batch of product. Therefore, the marker embodies a series of hierarchically coded information blocks which are accessed by knowledge of the entry point of the system. In order to reproduce the marker those so inclined would need to know where the entry point lies, the nature of the coded information and what the results obtained from the entry code level point to in terms of the next level of coded information to be analysed.

The present disclosure is comprised of an indicator, fingerprint and optionally a polymer base.

The indicator provides a method for establishing whether an item is marked and if so, the location of the mark. However it may also be used as a “lock and key” mechanism as described above

The product can be water or solvent based and can contain a dissolved or dispersed polymer solution or dispersion. Both are designed to allow transferability while the product is wet and then to form a clear, discrete surface coating when dry. The marker system preferably includes a matrix and an aqueous polymer emulsion to bind a marker to the surfaces of items, articles, goods, vehicles and/or premises. Advantageously, the polymer system, which may be water based to avoid the use of solvents, initially acts as an adhesive to secure the marker or surface coating to the goods being protected. As the goods may be subject to high temperatures, it may be desirable for the matrix to be able to withstand high temperatures; failing which, the matrix may lose its adhesion to the surface, by for example carbonising, and the marker system will simply fall off the surface, when the marker system is subjected, either directly or indirectly, to high temperatures. In order to ensure that a stolen item is identifiable even where it has been subjected to heat; it is desirable for the polymer emulsion and matrix combination to secure the marker system across a wide range of temperatures.

The main polymer may be an acrylate emulsion, but scattered into that at manufacture could be a fine polymer powder, like a dust, based upon possibly a styrene/butadiene copolymer. The presence of this second polymer scattered randomly into the first would be impossible to detect without specialised equipment. The second polymer could be easily detected by equipment that would take the average of an area, but the scattered nature of this particle based second polymer would be more difficult to detect.

Additionally the main polymer providing the main surface coating of the product may be changed and combinations of two or more polymers may be used at varying ratios.

Various fingerprint technologies can be used singly or in combination with the preferred product containing at least two such technologies. The chemical and metallic fingerprints are based upon mixtures of components used only once and not repeated. A particle based coding can also be used and which may use colour or numeric coding of pieces of plastic that are small enough to be difficult to detect with the human eye. They may also represent a different chemical composition to the polymer used in the main product composition.

The fingerprint may comprise a solvent medium containing a volatile component, together with for example one or more trace materials which can be varied in such a manner as to produce unique formulations. The combinations of trace materials may advantageously be varied by modelling the compositions on, for example, binary strings to produce large numbers of unique products. However, other suitable coding methodologies may also be utilised as appropriate. The term “trace materials” applies herein to materials which would not normally be present in the environment of use. The most commonly used trace materials are metal compounds.

Trace materials can advantageously therefore be combined in a way which gives good evidential value to law enforcement agencies, as each unique formulation may be allocated to a particular premises, location or person, and this information is stored in a central database which can be accessed by a law enforcement agency receiving the report of a laboratory analyzing the mixtures which are to be discussed.

The trace materials may be assigned constant positions in a binary string with their presence being given by a “1”, and their absence by a “0”. If, for example, one were to set a limit of thirty digits for the string, one could begin with combinations of two trace materials, and generate all combinations containing any two trace materials. One could then go to groups of three trace materials, and generate all combinations of any three trace materials. This could continue until the number of trace materials is equal to the number of digits in the string.

With a thirty digit string, the total number of unique combinations of trace materials is approximately one billion. However, it is possible to prepare an infinite number of mixtures having compositions based upon unique binary sequences, the composition of each being unique.

Binary strings are provided as exemplary of the manufacturing procedures which can be used. Octal strings may also be used. Decimal numbers and random number generation can be used to generate potential codes, although these will need to be checked and converted to binary or octal sequences prior to use.

The unique nature of each composition can be checked during Quality Control following manufacture. The composition can then be stored in a database, allocated to a premises, location, or person, and the source of goods located at a later time can be traced to the premises, location or person via the composition.

Of course, the greater the number of trace materials used, the greater the certainty in identification later on, since the chance presence of trace materials can be ruled out.

In one embodiment of the present disclosure, inorganic materials may be used as the fingerprint. These materials have the best performance, of the materials tested.

A preferred fingerprint for use in the present disclosure is an organometallic material.

The present disclosure provides an improvement in the effectiveness of marker systems in that it provides a series of interlocking codes, each one providing a unique code which when taken together would represent a serious challenge to those endeavouring to duplicate it.

The exact operation of the method is flexible and those skilled in the art will have their own approach, but this does not detract from the scope of the present disclosure. Typical levels which could be included are:

Level 1

Firstly the indicator, which in the case of a covert indicator, provides just the one repeatable output to a given stimulation. This could be stimulated by UV and provide a coloured output that identifies the system is in use. Further to this it may provide information on the level two analysis that is required.

Level 2

The technique chosen here may have sufficient flexibility so that it can provide information on the other coding systems used within the batch of product under analysis. Various techniques could be used such as trace component analysis, or coded plastic particles. Analysis of the data provided from such techniques would indicate an initial identification and also what other forms of analysis are required in this particular case. It would indicate which level 3 analysis was required. Such level 2 analysis would indicate whether:
Polymer analysis was required
DNA analysis was required
Whether coded particles are present
Whether secondary fluorescence should be present

Level 3

The analysis of one or more of the above, as indicated by the level 2 code, could be undertaken to determine variations in each of the above are present in the sample in hand. Such options could be:

Polymer Analysis

This could be undertaken to identify:
the polymer present
qualitative analysis of the polymer blend present
quantitative analysis of the components of a blend
the presence of any polymer material dispersed into the polymer body

In third case above each blend could be made of two polymers each present at 3 levels. Assuming a two polymer blend, polymer A and B, these would consist of a low concentration of polymer A and high B, equal concentrations of A and B, with the third option being a blend with a high concentration of A and low B.

In addition to this polymer analysis could also be used to confirm the presence or absence of a polymer dust added to the gross polymer. Various scanning techniques could be used such as scanning Fourier Transform Raman microscopy to determine the presence or absence of this low level additive across the surface of the polymer.

DNA Analysis

This would be undertaken were indicated by the second level code. Due to the low inherent stability of this type of material, it is an unlikely candidate, however it could be suitable for some carefully vetted benign environments.

Coded Particles

If level 2 analysis indicates the presence of this type of coding then it may be present in several different forms. Some of these include numerically coded micro-particles, colour coded micro-particles, or both. The colour coded particles consist of particles of plastic with colour coded layers providing the necessary coding.

Secondary Fluorescence

The initial indication of the system in use may be inflexible and provided by a recognised form of stimulation, UV fluorescence using 365 nm wavelength radiation being the most common. However once that has been achieved further coding may be incorporated into the indicator through the use of a short duration phosphorescence, emitting either the same or different colour as the fluorescence. In addition the indicator could also contain a component which only emits under a secondary form of stimulation, such as IR light. Part of this output could be used to determine the level 2 coding as discussed above.

The level of coding available through the combination of each of these different features is large, some idea of the extent can be obtained by a quick approximation.

Assuming:

20 trace components

18 qualitative and quantitative polymer blends

Coded particles—typically 1 billion codes available

Secondary fluorescence—typically 10 codes available

DNA was not included as it is not suitable for general purpose application

Very approximately this is equivalent to 1025 which in practical terms is sufficient to qualify as infinite.

These and other features and characteristics, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of claims. Claims

1. A security marker comprising:
i) a first level of the marker comprising an indicator, and
ii) a second level of the marker;
wherein the security marker is configured such that an identification of one or more characteristics of the first level of the marker provides information to enable or facilitate identification of one or more characteristics of the second level of the marker.

2. The security marker according to claim 1, wherein the second level of the marker comprises a characteristic fingerprint.

3. The security marker according to claim 1, wherein the indicator includes a plurality of elements.

4. The security marker according to claim 1, wherein the indicator is covert.

5. The security marker according to claim 1, wherein the indicator serves to locate a position of the marker.

6. The security marker according to claims 1, wherein the indicator provides different outputs when subjected to different forms of stimulation, such outputs forming part of a marker code for the first level of the marker.

7. The security marker according to claim 1, wherein the second level of the marker determines a marker code indicative of whether other interrogation levels present in the marker.

8. The security marker according to claim 1, further comprising a polymer base.

9. The security marker according to claim 8, wherein the polymer base forms part of a marker code by virtue of its identity.

10. The security marker according to claim 8, wherein the polymer base forms part of a marker code by virtue of a qualitative blend of polymers

11. The security marker according to claim 8, wherein the polymer base forms part of a marker code by virtue of a quantitative blend of polymers.

12. The security marker according to claim 8, wherein the polymer base forms part of a marker code by virtue of a finely divided polymer dust dispersed into the bulk polymer

13. The security marker according to claim 2, wherein the fingerprint is any of DNA, a chemical fingerprint, a metal based fingerprint, or coded particles, polymer combinations, or ratios of polymer combinations, or dispersed polymer powder or combinations of any of these.

14. The security marker according to any of claim 2, wherein a polymer base also comprises part of the fingerprint.

15. A multilevel security marker containing multiple components, wherein each component is provided with one or more of a series of hierarchical codes or identifiers configured such that an identification of a first of the codes or identifiers in the series in a first component identifies a nature of a next code or identifier in the series in the same or a different component.

16. A security method comprising:
providing an item having a security marker characterized by a first interrogation level;
examining the first interrogation level to identify one or more characteristics of the first interrogation level representing a marker code for the first interrogation level;
utilizing a predetermined correlation to interpret the marker code for the first interrogation level and thereby identify a second interrogation level of the marker. examining the second interrogation level of the maker to identify one or more characteristics of the second interrogation level; and
making a security determination with respect to the item based at least in part on the identified one or more characteristics of the second interrogation level.

17. The method of claim 16, wherein the security determination is a determination of whether the item is an authentic item.

18. The method of claim 16, wherein the security determination is a determination of whether the item is a stolen item.
